(19) United States
(12) Patent Application Publication
(10) Pub. No.: US 2015/0075860 A1
(43) Pub. Date: Mar. 19, 2015

(54) Expandable Electrical Entry Box for Hollow Wall

(71) Applicants: Harry A. Edwards, Marietta, GA (US); T. Michael Gorin, Atlanta, GA (US); James Loye Hutchinson, Dallas, GA (US)

(72) Inventors: Harry A. Edwards, Marietta, GA (US); T. Michael Gorin, Atlanta, GA (US); James Loye Hutchinson, Dallas, GA (US)

(73) Assignee: DATACOMM ELECTRONICS, INC., Norcross, GA (US)

(21) Appl. No.: 14/465,051

(22) Filed: Aug. 21, 2014

Related U.S. Application Data
(60) Provisional application No. 61/874,465, filed on Sep. 6, 2013.

(51) Int. Cl. H02G 3/10

(52) U.S. Cl. CPC H02G 3/10
USPC 174/504

(57) ABSTRACT

A cable entry box for mounting in a drywall panel, including a front opening for alignment with an opening in the drywall panel and a side opening to receive an expansion pocket that protrudes beyond the cable entry box, internally of the drywall panel for receiving electrical wiring and other components that are to be supported interiorly of the drywall structure.

### PRIORITY

Applicants claim priority under 35 U.S.C. 119(e) for the benefit of prior filed provisional application 61/874,465, filed Sep. 6, 2013.

### BACKGROUND OF THE INVENTION

This disclosure concerns low voltage cable entry boxes with or without high voltage outlets for mounting electrically powered products to walls in building structures such as homes and apartments. The boxes are used for connection of communication cables and low voltage components in dry wall structures to flat screen televisions, flat panel displays and the like, with or without a high voltage electrical outlet.

In recent years, TVs have been produced that have display screens that are much wider and higher than the previous TVs, and the sets usually are thin so that they can be mounted on a vertical wall.

In new and in retrofit building construction where hollow wall structures are being formed, low voltage cable entry boxes may be mounted in the drywall of the building structure where TVs and other flat panel displays and the like are to be positioned. The cable entry boxes are used to provide a space to connect low voltage cable to a TV, etc. After the wall has been built out, a flat screen TV or other flat panel display can be mounted to the wall in front of the cable entry box. The cables extending through the hollow drywall structure to the cable entry box are then connected to the TV. It is desirable to make the wall opening of the cable entry box relatively small so that the cable entry box may be used to mount small flat screens to the wall without visually exposing the presence of the box or the cables and wires extending from the box to the TV.

Also, when the cable and wires are pulled into the cable entry box, some lengths of the cable and wire must be available to the installer to handle and make the proper connections to the flat panel display, and the extra length of the cable and wire might not properly fit in the space available in the small entry box. In some situations, it is desirable to mount other low voltage items in the entry box, such as network media player/streamers, wire extending devices, HDMI extenders, and electronic transmitter or receiving devices. The cable entry boxes may be too small to accommodate the extra cable and the above listed devices. This may require a larger cable entry box that is too large for hiding behind the flat panel display screen.

Accordingly, it would be desirable to provide an expandable cable entry box for mounting in a hollow wall structure with the box having a small entry opening but also having a means for expanding the internal dimensions of the box inside the hollow wall structure to form a pocket inside the drywall structure for additional cable and wiring and other low voltage devices such as listed above or that are used to power the flat panel display. It is desirable that the internal dimensions of the cable entry box be larger than the opening extending from the box through the drywall to the display.

Further, it would be desirable that the cable entry box be expandable so that it can be used in either a small or a large internal configuration to accommodate the cable, electrical wiring, and other low voltage devices.

Further, it would be desirable that the cable entry box assembly be provided that is optionally expandable at the job site, which can be packaged in a small container for delivery to the job site and placement through the opening in the hollow dry wall structure, and that would provide the option to the installer to use in a small or a large configuration inside the wall structure, as the need exists.

### SUMMARY OF THE INVENTION

This invention concerns a cable entry box assembly primarily for mounting in a hollow drywall structure or the like for receiving low voltage electrical cable and other wiring and devices from within the drywall structure for connection to a TV or other electronic device mounted to the outer surface of the wall structure.

The cable entry box assembly includes a support box for inserting through an opening of the drywall panel of a building structure between internal supports of the drywall that form the internal wall space. The support box has walls that define an internal cable space and its walls may include at least a top and/or bottom and/or side openings for passing cable into the internal cable space. The support box also includes a front opening for alignment with an opening in the drywall. One or more of the walls of the support box may include a side opening sized and shaped to register with an electrical power plug receptacle.

An expansion opening is formed in a wall of the support box with the opening sized and shaped to pass an expansion pocket from within the internal cable space beyond the limits of the front opening of the support box, to a position protruding beyond the support box and into an adjacent space in the drywall structure.

The expansion pocket is to move through the expansion opening behind the drywall panel so that expansion pocket is not viewable from outside the drywall when the display is mounted on the wall structure in front of the support box. The expansion pocket may be sized and shaped to be moved through the front opening of the support box into the internal cable space of the support box and then moved laterally through the expansion opening of the support box and extended farther into the wall space adjacent the support box behind the drywall for receiving electrical wiring and other components of the device to be supported interiorly of the wall structure.

This arrangement accommodates the additional cable and/or electronic components so as to retain the small opening extending through the drywall and utilizing the additional space in the drywall adjacent the cable entry box without exposing the extra space or its contents through the drywall.

Also, the invention may be summarized as an expandable cable entry box assembly mounted through a wall opening in a panel of a hollow drywall structure for supporting low voltage cable in the hollow drywall structure, with the assembly including a cable support box defining a front opening in registration with the wall opening, an internal cable space, and a side opening, an expansion pocket extending from the internal cable space through the side opening of the cable support box and away from the cable support box into the drywall structure beyond the cable support box behind the dry wall panel and not visible through the dry wall panel and enlarging the interior size of the cable entry box assembly, and low voltage cable extending into the internal cable space of the cable support box and from the internal cable space into the expansion pocket and back from the expansion pocket through the internal cable space.

Other objects, features and advantages of the present invention will become apparent upon reading the following specification, taken in conjunction with the accompanying drawings.

### BRIEF DESCRIPTION OF THE DRAWINGS

FIG. 1 is a perspective view of a portion of a drywall structure with the expandable cable entry box assembly mounted therein.

FIG. 2 is a perspective view of the cable support box of FIG. 1 that is to be mounted through an opening in the drywall of a building structure, extending into the hollow internal portion of the drywall.

FIG. 3 is a perspective expanded view of the expandable cable entry support box assembly, showing it adjacent the drywall structure.

FIG. 4 is a top cross sectional view of a segment of a drywall structure with the opening formed in one of the wall panels, showing the support frame and plug receptacle mounted to the support frame and positioned internally of the drywall.

FIG. 5 is a top cross sectional view of the drywall segment, taken along lines 5-5 of FIG. 1, showing the cable entry support box positioned internally of the drywall, and with the external frame that surrounds the opening of the drywall mounted thereto.

FIG. 6 is a top cross sectional view of the drywall segment along lines 5-5 of FIG. 1 and similar to FIG. 5, but with the expansion pocket positioned in the internal space of the support box for convenience in shipping, storing, removing and mounting in the cable entry box assembly.

FIG. 7 is a top cross sectional view of the drywall structure, similar to FIG. 6, but showing how the expansion pocket is moved from the internal space of the support box, laterally into the adjacent space of the drywall structure, behind the drywall panel.

FIG. 8A is a top cross sectional view and FIGS. 8B and 8C are perspective views of the expandable cable entry box assembly, showing openings in the top and bottom walls of the support box when the expansion pocket has been moved through the opening in a side wall of the support box.

FIG. 9 is a perspective view of another embodiment of the assembled expandable cable entry box, showing the upper and lower walls defining openings therethrough, with panels closing the openings when they are not in use.

FIGS. 10A and 10B are illustrations of the assembled expandable cable entry box, similar to FIG. 9, but showing in FIGS. 10A and 10B a six port keystone cover plate in the top wall, and showing in FIG. 10B “star shaped” openings in the bottom wall of a flexible panel for the passage of cable, similar to that shown in U.S. Pat. No. 7,495,171.

### DETAILED DESCRIPTION

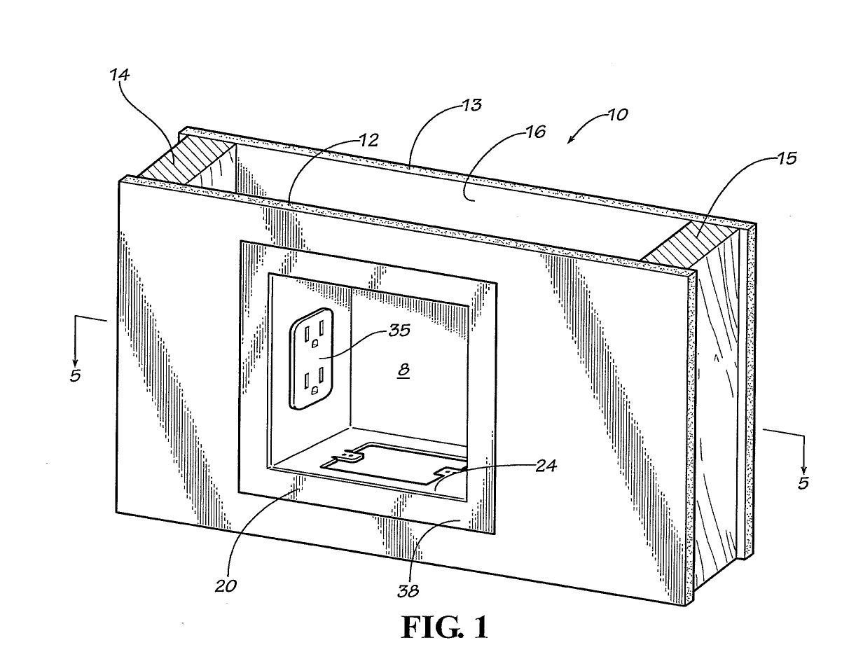

Referring now in more detail to the drawings, in which like numerals indicate like parts throughout the several views, FIG. 1 illustrates an expandable cable entry box assembly 8 mounted in a drywall structure 10. The dry wall structure is formed with front and rear parallel drywall panels 12 and 13, with the panels mounted to vertically oriented studs 14 and 15. This leaves a series of internal spaces in the drywall structure 10. The cable entry box 8 is mounted in one of the internal spaces 16 between the studs 14 and 15.

While this disclosure specifically refers to and illustrates a conventional drywall structure as structurally described, the invention may be used in other types of hollow wall structures.

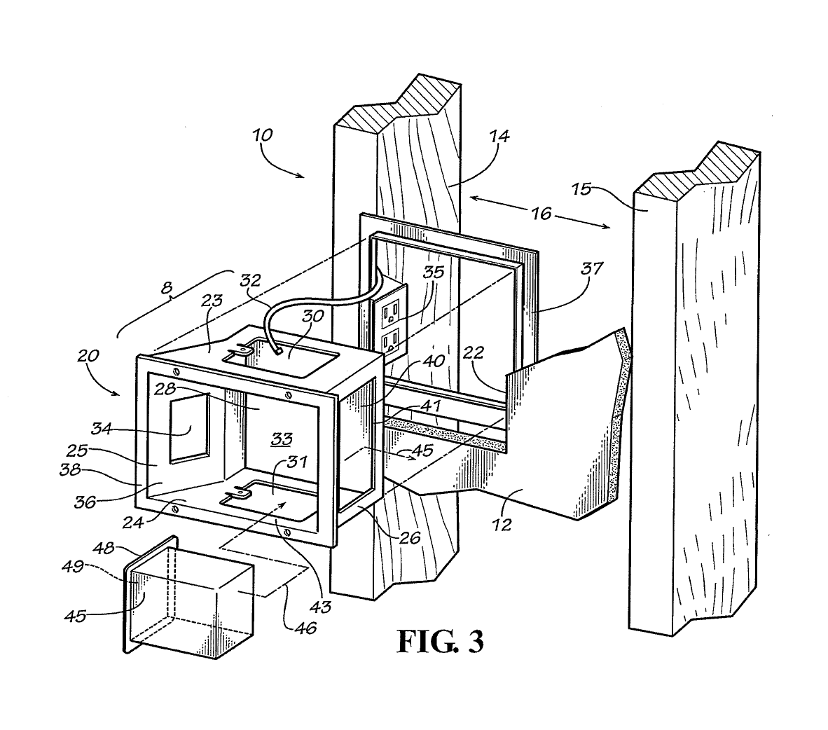

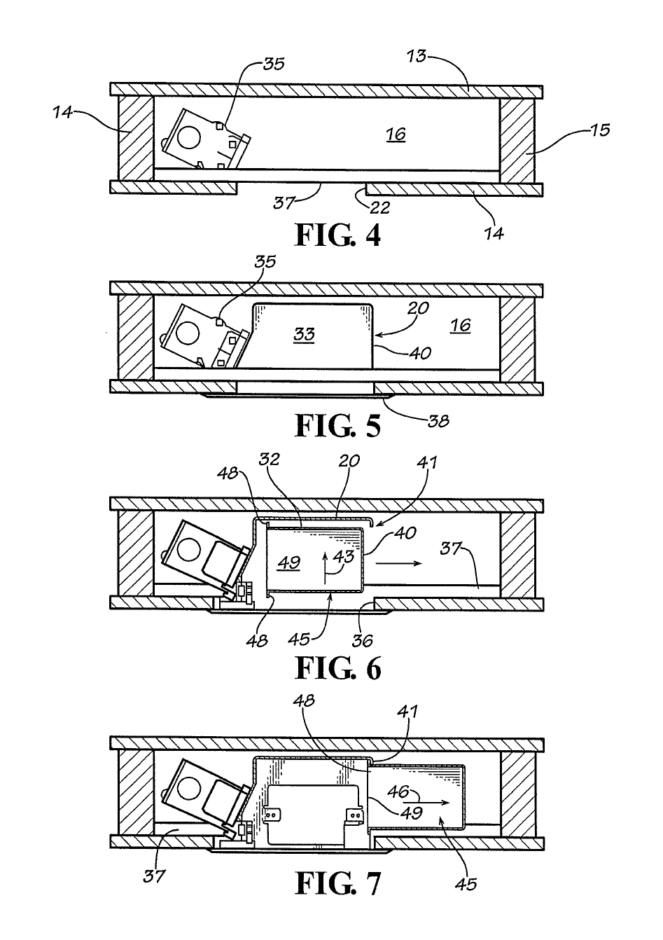

The assembled cable entry box assembly 8 as shown in FIG. 1 includes a cable support box 20 that is mounted through an opening 22 (FIG. 3) in the front drywall panel 12. The cable support box includes perimeter walls, including parallel top wall 23 and bottom wall 24, and parallel side walls 25 and 26, that extend between the front and rear dry wall panels 12 and 13. The support box 20 is inserted through the opening 22 of the first drywall panel 12 between the internal supports 14 and 15 that form the internal wall space 16. The support box 20 includes an internal cable space 33 defined by the perimeter walls 23-26. Top wall opening 30 is formed in the top wall 23 and the bottom wall opening 31 is formed in the bottom wall 24. The top and bottom wall openings may be used to introduce electrical cable 32 and other items that extend from the drywall structure into the internal cable space 33.

First side wall 25 of the cable support box 20 defines a plug receptacle opening 34 that is to be aligned with and to surround the plug receptacle 35, as shown in FIG. 1. In new construction the plug receptacle 35 may be mounted on a conventional support frame 37 that is well known in the prior art, to be mounted at this position prior to the insertion of the cable entry box in the drywall structure.

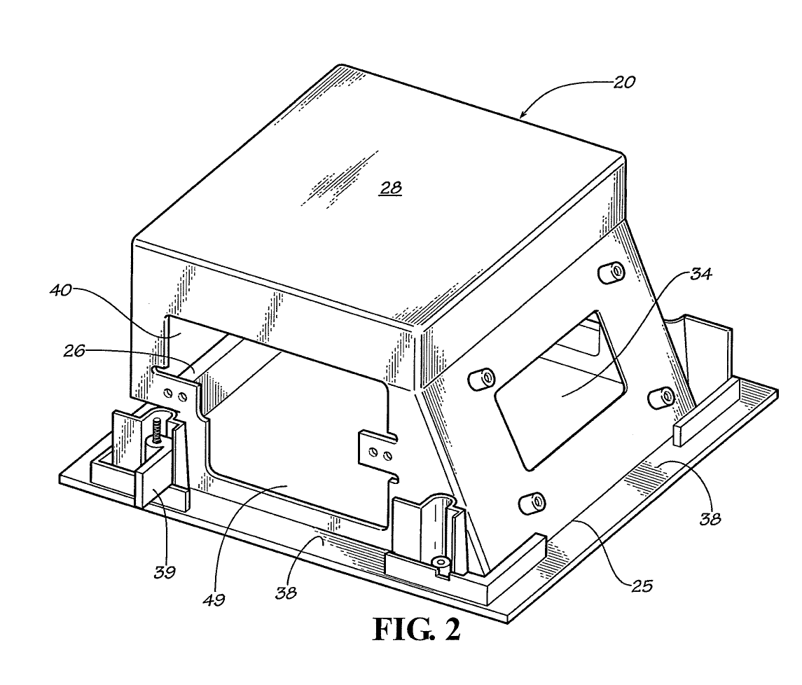

When it is not practical to use a support frame 37 behind the wall panel, such as in a retrofit in an existing wall structure, the perimeter frame 38 of the support box 20 illustrated in FIG. 2 may be mounted against the outer surface of the edge of the dry wall opening 22 in the dry wall panel 12 of the dry wall structure 10, and conventional lock tabs 39 may be pivoted out from the perimeter frame behind the wall panel to secure the support box in its internal position behind the wall panel. The perimeter frame 38 functions as retaining means for retaining the support box at the opening in the wall panel. Other retainers may be used for the function of retaining the support box in position at the opening in the wall.

As shown in FIG. 3, a large front opening 36 of the support box 20 is positioned at the face of the support box 20 and is bordered by the perimeter frame 38. The perimeter frame extends outwardly from the perimeter walls 23-26 of the support box 20 and, as described above, is used to engage the facing exterior perimeter surface about the drywall opening 22 to securely suspend the support box 20 in the internal wall space between the studs 14 and 15 of the drywall structure 10.

The second side wall 26 that opposes the first side wall 25 of the support box defines an expansion opening 40 of a shape that permits passage of an expansion pocket 45 or an electrical component through the side of the support box. For example, the expansion opening 40 may be formed in a rectangular shape as shown but may be of other shapes compatible with the function and shape of the cable entry box and the items to pass through the expansion opening. The expansion opening 40 is to be positioned interiorally of the drywall space 16 when the support box 20 is inserted through the opening 22 in the drywall panel 12.

As shown in FIGS. 3 and 6, expansion pocket 45 has side walls 47 and bottom wall 50 that may be sized and shaped to conform to the shape of the expansion opening 40 of the side wall 26 and opening 54. The expansion pocket is of a breadth and shape to be moved through the large front opening 36 of the support box 20 as indicted by arrow 43 of FIGS. 3 and 6 and to fit within the internal cable space 33 formed by the support box. This allows the expansion pocket 45 to be stored in the internal cable space 33 of the support box 20 with the size of the overall package being small for purposes of shipment and for convenience of access and in removing from or using with the support box 20.

FIG. 6 shows the expansion pocket 45 in its stored position when, for example, the entry box assembly 18 is being shipped or stored but not yet in use. If the expansion pocket is not needed for the job site, it may be simply removed from the internal cable space 33 of the support box 20, by withdrawing it through the large front opening 36. However, if additional storage space or space for other purposes is desirable in the support box assembly, once the support box 20 has been placed in the internal space 16 of the dry wall structure as shown in FIG. 6, the expansion pocket 45 may be moved laterally through the expansion opening 36 as indicated by the arrow 43 of FIGS. 3 and 7. A lateral protrusion, such as perimeter rim 48, extends outwardly from the pocket entrance opening 49 (FIG. 6) of the expansion pocket to a distance to engage the internally facing edge 41 of the expansion opening 40 of the support box 20 upon moving a predetermined distance through the expansion opening. This limits the distance that the expansion pocket 45 can move through the expansion opening 40 of the support box 20.

From the previous description, it will be understood that the installer of the cable entry box assembly has the option to retrieve the expansion pocket 45 from the support box 20 as shown in FIG. 3 or to move the expansion pocket 45 through the expansion opening 40 of the support box 20, as shown in FIG. 7.

When the expansion pocket is moved on through the expansion opening 40, this substantially increases the internal space that is defined by the support box assembly, providing additional space beyond the limits of side wall 26 in which to place additional electronic components to be connected to the flat panel display and associated equipment, such as, but not limited to, slack in the cable, electronic transmitting devices, network media player/streamer, and other components desired for mounting at the site of the flat panel display unit that is mounted in the wall opening. Low voltage cable 32 may extend from the interior of the hollow wall structure 10, through bottom wall opening 31 of the cable support box 20 and into the internal cable space 33, and from the internal cable space of the cable entry box into the expansion pocket 45, and back from said expansion pocket into the internal cable space of the cable entry box, and through the large front opening 36 for connection to the back of a flat screen TV or other flat screen device.

This also retains the small size of the opening 22 formed through the drywall of the drywall panel 12, reducing the likelihood that the support box assembly will be exposed from behind the small flat screen TV.

The support box is reversible in the sense that the expansion pocket may be oriented to extend inside the drywall beyond the wall opening either left or right or up or down, providing the installer a choice where the TV set is to be mounted. For example, if the cable entry box is to be placed adjacent an internal wall stud, the cable entry box may be oriented to have the expansion pocket protrude from the side of the support box that faces away from the adjacent stud.

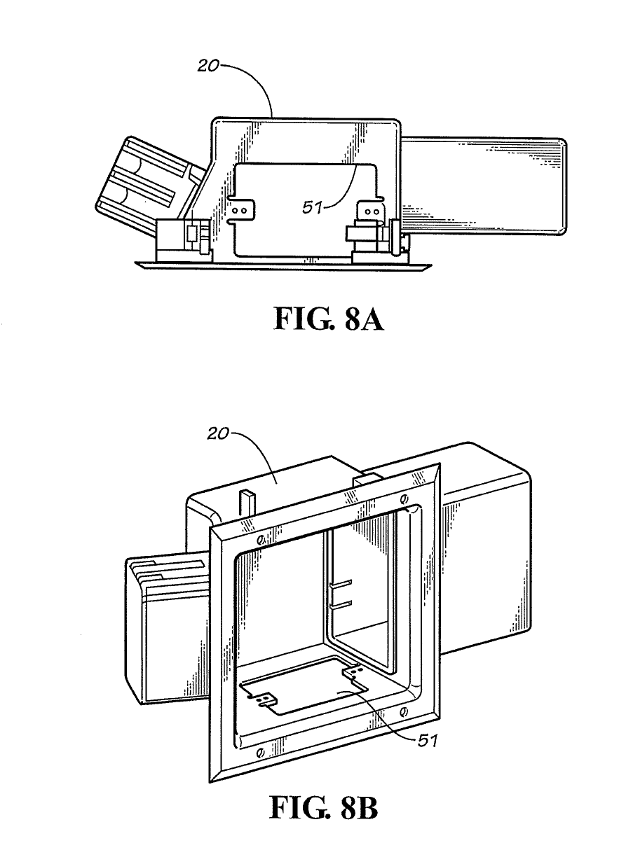

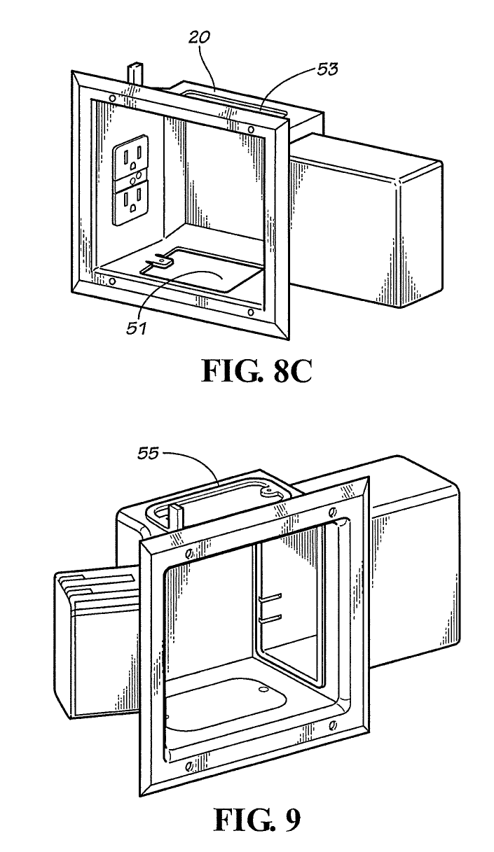

FIGS. 8A, 8B and 8C show other embodiments of the support box 20 in which openings 51 are formed in the bottom walls of the support box 20. Other sized and shaped openings may be formed in the support box, as may be desired or necessary.

FIG. 9 shows a perimeter rim 55 that may be mounted about the edge of a top wall opening so that other items may be mounted thereto.

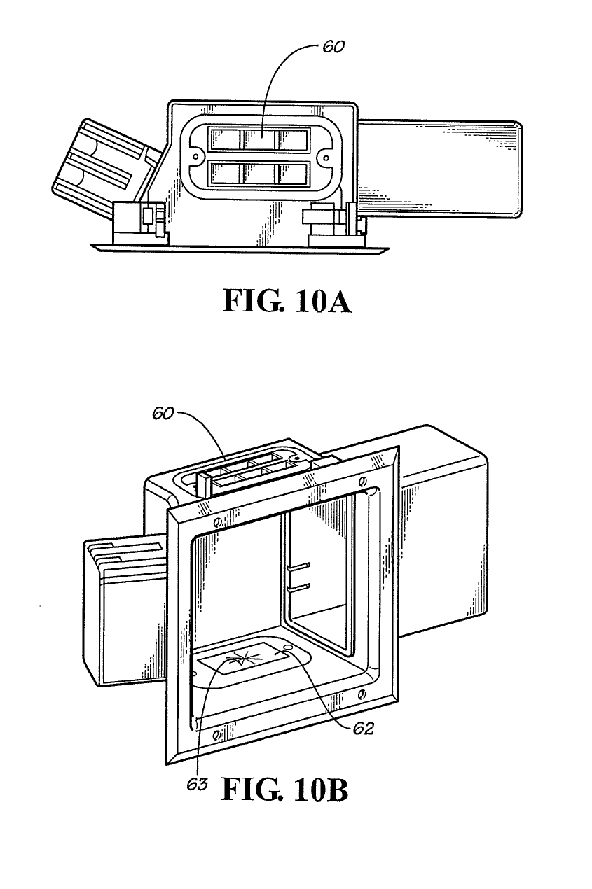

FIGS. 10A and 10B illustrate a six-port keystone plate 60 that may be mounted to the top wall of the support box, and FIG. 10B shows a flexible sheet 62 with a star cut opening 63 formed therethrough for the passage of cable. This type of opening is shown in more detail in U.S. Pat. No. 7,495,171.

While the expandable cable entry box has been disclosed as accommodating low voltage electrical components and cables in a hollow wall structure, the expandable entry box may be used for other purposes. The expansion pocket 45 may be made in other shapes and materials, such as, but not limited to, transparent materials.

Although a preferred embodiment of the invention has been disclosed in detail herein, variations and modifications of the disclosed embodiment can be made without departing from the spirit and scope of the invention as set forth in the following claims.

1. An expandable electrical cable entry box assembly for mounting through an opening of a wall panel of a hollow wall structure into a space between the wall panels for supporting low voltage cable between the wall panels, comprising:
a cable support box sized and shaped to move through the opening of the wall panel and into the hollow wall structure,
said cable support box including opposed perimeter side walls sized and shaped for extending between the wall panels of the hollow wall structure, said perimeter walls defining there between an internal cable support space and a front opening for alignment with the wall opening of the hollow wall structure and sized for passing electrical cable from the internal cable support space through the wall opening of the wall panel,
at least one of the perimeter walls of said cable support box defining a side expansion opening between the internal cable support space and the outside of the cable support box,
an expansion pocket defining a pocket opening, said expansion pocket being sized and shaped to move through the front opening of said cable support box and into the internal cable support space of said cable support box, and to move from the internal cable support space through the side opening of said perimeter wall of said cable support box and project into the space between the wall panels of said hollow wall structure with the pocket opening facing said internal cable support space, and
a retainer for maintaining said expansion pocket in alignment with the side opening of said perimeter wall for storing electrical components.

2. The expandable electrical cable entry box assembly of claim 1, wherein said retainer for retaining said expansion pocket in alignment with the side opening of the perimeter wall comprises a protrusion at said pocket opening that engages the edge of the side expansion opening of said cable support box.

3. The expandable electrical cable entry box assembly of claim 1, wherein said retainer for retaining said expansion pocket in alignment with the side opening of the perimeter wall comprises a rim at said pocket opening that engages the edge of the side expansion opening of said cable support box.

4. The expandable electrical entry box assembly of claim 1, and further including a perimeter frame surrounding said front opening of said cable support box sized to engage the wall panel at the wall opening.

5. An expandable cable entry box assembly configured for placement in a hollow wall structure for supporting low voltage cable, comprising:
a cable support box sized for passing through an opening in the hollow wall for placement in the hollow wall at the opening of the hollow wall,
a perimeter frame mounted to said cable support box for positioning said cable support box at the opening in the wall structure,
said cable support box including walls defining an internal cable space,
an expansion pocket opening formed in one of said walls,
an expansion pocket sized to pass from said internal cable space through said expansion pocket opening and forming a space outside of said cable support box and facing the internal cable space of said cable support box.

6. The expandable cable entry box assembly of claim 5, and further including a retainer for retaining said expansion pocket in alignment with the expansion pocket opening.

7. The expandable electrical cable entry box assembly of claim 6, wherein said retainer for retaining said expansion pocket in alignment with the expansion pocket opening comprises a rim at said pocket opening that engages the cable support box at the expansion opening of said cable support box.

8. An expandable cable entry box assembly mounted through a wall opening in a panel of a hollow drywall structure for supporting low voltage cable in the hollow drywall structure, including:
a cable support box defining a front opening in registration with the wall opening, an internal cable space, and a side opening,
an expansion pocket extending from said internal cable space through said side opening of said cable support box and away from said cable support box into the drywall structure beyond said cable support box behind the dry wall panel and not visible through the dry wall panel and enlarging the interior size of said cable entry box assembly, and
low voltage cable extending into said internal cable space of said cable support box and from said internal cable space into the expansion pocket and back from said expansion pocket through said internal cable space.

9. The cable entry box assembly of claim 8, wherein said expansion pocket is sized and shaped to fit in said internal cable space for shipment of the cable entry box assembly, and to be moved from said internal cable space partially through a side opening of said support box and protrude from said internal cable space of said cable entry box into the wall structure.
